(19) United States
(12) Patent Application Publication
(10) Pub. No.: US 2001/0039715 A1
(43) Pub. Date: Nov. 15, 2001

(54) SUBSTRATE MANUFACTURING PLANT HAVING MINIMUM FOOTPRINT SKINNED LINES

(75) Inventors: RICHARD POMMER, COSTA MESA, CA (US); RICHARD HAGAN, COSTA MESA, CA (US)

Correspondence Address: CURTIS BRUESKE, ALLIEDSIGNAL INC, 101 COLUMBIA ROAD P O BOX 2245, MORRISTOWN, NJ, 079621057

(73) Assignee: pommer

(21) Appl. No.: 09/432,201

(22) Filed: Nov. 2, 1999

(51) Int. Cl. B23Q 41/00; B01L 1/04

(52) U.S. Cl. 29/564; 454/187; 52/171.1; 52/206

(57) ABSTRACT

A substrate manufacturing plant comprising a plurality of minimum footprint skinned lines and methods relating to same. Specifically, a plant comprising a plurality of lines each line capable of accomplishing one step of a manufacturing process; the lines arranged in the order of their respective manufacturing steps so as to minimize the time necessary to process a work piece through all the lines; at least one line enclosed in its own environmental enclosure. By utilizing enclosures having the minimum size necessary to enclose and operate a single line or machine and arranging those enclosures in a linear fashion, parts progress linearly through the modules from start to finish without having to pass through a particular module more than once during processing. Because the size required to house a single machine is much smaller than a room designed to house multiple machines and people, control of the environment within the modules is relatively easy and cheap to accomplish.

### FIELD OF THE INVENTION

The field of the invention is printed circuit board and integrated circuit substrate manufacturing plants.

### BACKGROUND OF THE INVENTION

A plant can be defined as the equipment, including machinery, tools, instruments, and fixtures, and the buildings containing them, necessary for an industrial or manufacturing operation. Printed circuit board (PCB) and integrated circuit (IC) substrate manufacturing plants are typically divided into large individual rooms, with each room being devoted to and customized for a particular part of the manufacturing process. As an example, all wet processing might be done in a single room as might all drill and lasing. Any particular room might contain multiple machines devoted to performing the same processing step.

The use of a large individual room customized for a particular part of the manufacturing process minimizes the chance of cross-contamination between processes. Thus, airborne contaminants from one process are not likely to interfere with another process being performed in a different room. The grouping of machinery within a room also allows for maximum usage of the machinery in that any unit to be processed can be processed on any idle machine.

The use of large individual rooms does however, have some disadvantages. Because the rooms house multiple machines and the people utilizing them, maintaining tight environmental control with the rooms tends to be both difficult and expensive. This problem can be exacerbated if people move in and out of the room frequently.

Moreover, the grouping of machinery used to perform a given process within a single room results in parts having to be moved into and out of the room each time that process must be performed. The need to return to a particular room every time a process is to be performed results in loop-backs in the flow path a unit follows as it progresses through the plant. Such loop-backs make arrangement of equipment within the plant more difficult, tends to waste time and energy moving units around the plant, and may make it necessary to constantly reconfigure equipment based on the current unit being worked on with a corresponding loss in time and energy.

As the use of ICs and PCBs increases, the need for efficient manufacturing plants and methods will also increase. Thus there is a continuing need to improve on existing and on developing new methods and devices from manufacturing ICs and PCBs.

### SUMMARY OF THE INVENTION

The present invention is directed to a substrate manufacturing plant comprising a plurality of minimum footprint skinned lines and methods relating to same. Specifically, a plant comprising a plurality of lines each line capable of accomplishing one step of a manufacturing process; the lines arranged in the order of their respective manufacturing steps so as to minimize the time necessary to process a work piece through all the lines; at least one line enclosed in its own environmental enclosure. By utilizing enclosures having the minimum size necessary to enclose and operate a single line or machine and arranging those enclosures in a linear fashion, parts progress linearly through the modules from start to finish without having to pass through a particular module more than once during processing. Because the size required to house a single machine is much smaller than a room designed to house multiple machines and people, control of the environment within the modules is relatively easy and less expensive to accomplish.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a diagram view of a first method embodying the invention.

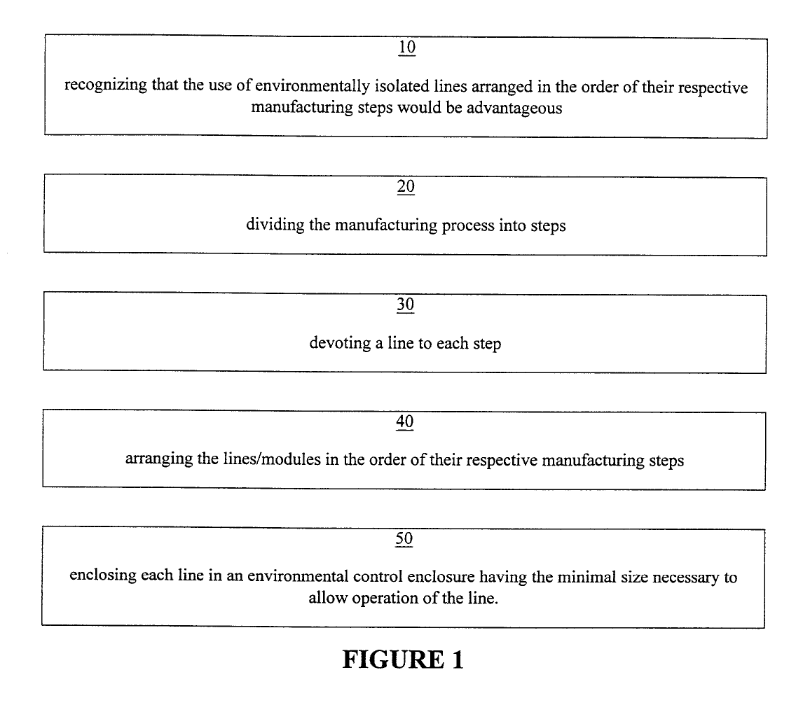

FIG. 2 is a perspective view of a first plant embodying the invention.

FIG. 3 is a flow diagram showing processing flow through lines of a plant.

### DETAILED DESCRIPTION

A preferred method for designing a plant to accomplish a manufacturing process includes the following: recognizing that the use of environmentally isolated lines arranged in the order of their respective manufacturing steps would be advantageous; dividing the manufacturing process into steps; devoting a line to each step; arranging the lines/modules in the order of their respective manufacturing steps; and enclosing each line in an environmental control enclosure having the minimal size necessary to allow operation of the line.

It is contemplated that because each process step is “skinned” (enclosed in an enclosure having the minimal size necessary to allow operation of the line) in a small footprint, the equipment controls are held much tighter at a lower cost. Another contemplated benefit of skinning the line is that tools can be lined up next to each other without cross contamination thus eliminating the need for large individual rooms.

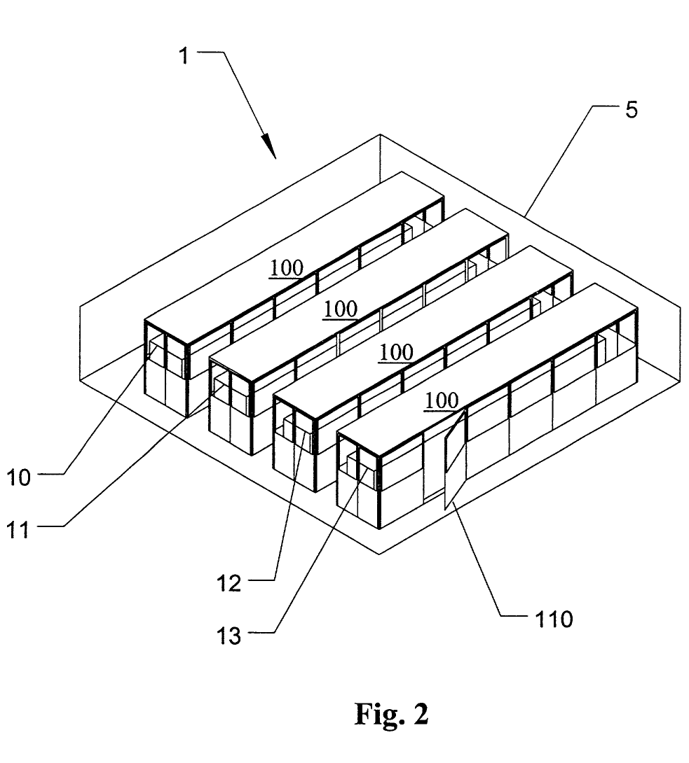

Referring to FIG. 2, a plant 1 designed utilizing the disclosed method would likely comprise: a plurality of lines 10-13, each line capable of accomplishing one step of a manufacturing process; the lines 10-13 arranged in the order of their respective manufacturing steps so as to minimize the time necessary to process a work piece through all the lines; and at least one line enclosed in its own environmental enclosure 100.

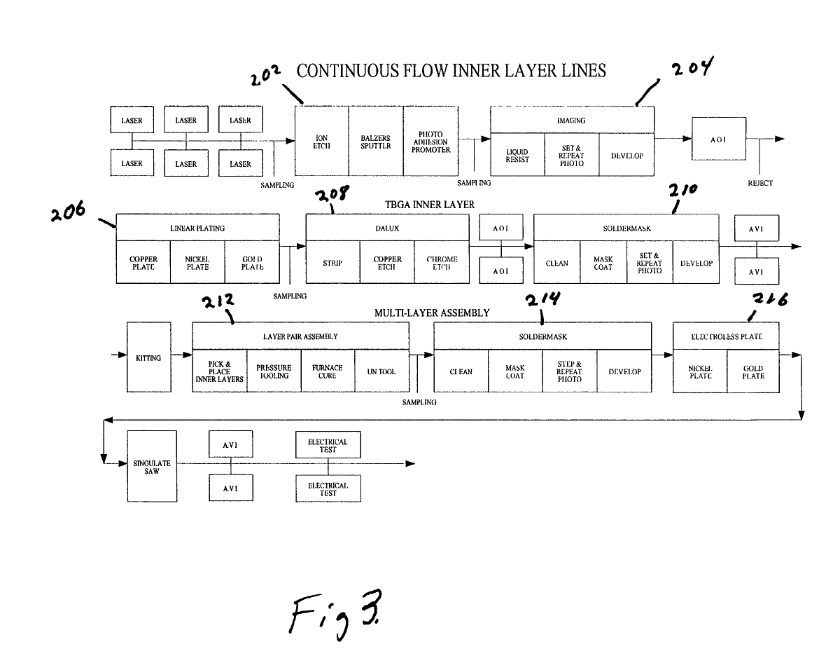

The lines 10-13 each comprise one or more machines or stations devoted to a step of the manufacturing process. It is contemplated that some embodiments may include, referring to FIG. 3, one or more of the following: a sputtering line 202, an imaging line 204, a linear plating line 206, a dalux (stip, copper etch, and chrome etch) line 208, a soldermask line 210 and 214, a layer pair assembly line 212, and an electroless plate line 216.

The environmental enclosure 100 is preferred to have the minimal size necessary to allow operation of its corresponding line. In some embodiments, the enclosure may be to small to allow an operator to completely enter the enclosure so operator access to the line would have to be achieved either remotely, or by reaching into the enclosure through an access port while standing outside the enclosure. Although the phrase minimal size is not limited to any particular configuration, some embodiments having may have an enclosure having a rectangular shape wherein each wall of the enclosure comes within X feet of the line where X is one of 0.5′, 1′, 1.5′, 2′, and 4′.

Environmental enclosures 100 are preferred to include windowed doors 110 which can be opened to allow operator access to the line, and, while opened or closed, allow supervision of a line by providing visibility to the line. Windowed doors 110 may be slide or swing open to allow access. In preferred embodiments the sides of enclosures 100 are preferred to substantially consist of doors 110 and their frames.

It is contemplated that in some embodiments, the skinned lines may be contained within a clean room 5 and the skin/enclosure 100 serve to at least partially isolate the environment within the enclosure 100 from the environment of the clean room 5 outside of the enclosure.

Thus, specific embodiments and applications of displays and methods for producing conservatively printed displays have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A manufacturing plant comprising:
a plurality of lines each line capable of accomplishing one step of a manufacturing process;
the lines arranged in the order of their respective manufacturing steps so as to minimize the time necessary to process a work piece through all the lines;
at least one line enclosed in its own environmental enclosure.

2. The plant of claim 1 wherein each environmental enclosure has the minimal size necessary to allow operation of its corresponding line.

3. The plant of claim 2 wherein operator access to at least one enclosed line is achieved by reaching into the enclosure through an access port while standing outside the enclosure.

4. The plant of claim 2 wherein operator access to at least one enclosed line is achieved by the operator entering into the enclosure through an access port.

5. The plant of claim 4 wherein the access port is a sliding or swinging door.

6. The plant of claim 1 wherein at least one enclosure is contained within a clean room and the enclosure serves to at least partially isolate the environment within the enclosure from the environment of the clean room outside of the enclosure.

7. The plant of claim 1 wherein the plant was designed by recognizing that the use of environmentally isolated lines arranged in the order of their respective manufacturing steps would be advantageous; dividing the manufacturing process into steps; devoting a line to each step; arranging the lines in the order of their respective manufacturing steps; enclosing each line in an environment control enclosure having the minimal size necessary to allow operation of the line.

8. A manufacturing plant comprising a plurality of minimum footprint skinned lines.
